(19) United States
(12) Patent Application Publication
(10) Pub. No.: US 2008/0311540 A1
(43) Pub. Date: Dec. 18, 2008

(54) Method and Device For Removing Biofilms By Microsteaming

(75) Inventors: Bart Gottenbos, Budel (NL); Joep Janssen, Herten (NL); Antonius Maarten Nuijs, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS, N.V., EINDHOVEN (NL)

(21) Appl. No.: 12/094,187

(22) PCT Filed: Oct. 27, 2006
(86) PCT No.: PCT/IB06/54463

§ 371 Date: May 19, 2008

Related U.S. Application Data
(60) Provisional application No. 60/740,158, filed on Nov. 28, 2005.

(51) Int. Cl. A61C 1/07

(52) U.S. Cl. 433/86

(57) ABSTRACT

A method of removing bio films from a surface is disclosed. The method includes a source of bubbles in a liquid medium being provided. The bubbles having a predetermined size. A source of ultrasound waves at a predetermined frequency also being provided. The bubbles in the liquid medium being output toward the surface. The ultrasound waves also being directed toward the surface so that the bubbles vibrate at the predetermined frequency of the ultrasound waves. The predetermined size of the bubbles is approximately related to the frequency of the ultrasound waves.

The present invention relates generally to personal care devices, and more particularly, to a device and method for removing biofilms from a surface using gas bubbles resonated by ultrasound waves.

The control of dental plaque is essential for oral health. Dental plaque is one example of a complex biofilm, which is a mixture of different species of bacteria. To control dental plaque, dentists recommend that everyone brush their teeth twice a day for at least 2 minutes. However, this does not remove all of the plaque since the toothbrush bristles cannot reach all the other areas in the mouth such as interproximal spaces or subgingival pockets.

Modern ‘sonic’ toothbrushes use fluid dynamics caused by higher frequency (260 Hz) bristle motion to disrupt the plaque in these hard to reach places. However, this fluid motion has a limited range of effectiveness of several millimeters and thus does not remove all the plaque in these places. Another problem is that people tend to comply only partly, if at all, to the daily brushing requirements.

Further, dentists also recommend that people extend their oral hygiene routine by including daily flossing. This is effective to remove plaque from hard to reach places. However, in practice people comply less with the daily flossing requirements, then the daily brushing requirements.

In view of the above, the present invention is directed to an oral cleaning device including a unit providing a source of bubbles in a liquid medium. The bubbles having a predetermined size. An applicator is coupled to the unit including at least one outlet for outputting the bubbles in the liquid medium and at least one ultrasound transducer for providing a source of ultrasound waves for vibrating the bubbles at a predetermined frequency. The predetermined size of the bubbles is approximately related to the frequency of the ultrasound waves by:

f₀R₀≈3ms⁻¹

where f₀ is the frequency of the ultrasound waves and R₀ is the radius of the bubbles.

The present invention is also directed to a method of removing biofilms from a surface. The method includes a source of bubbles in a liquid medium being provided. The bubbles having a predetermined size. A source of ultrasound waves at a predetermined frequency also being provided. The bubbles and liquid medium mixture being output toward the surface. The ultrasound waves also being directed toward the surface so that the bubbles vibrate at the predetermined frequency of the ultrasound waves. The predetermined size of the bubbles is approximately related to the frequency of the ultrasound waves by:

FIG. 1 is one example of an oral cleaning device according to the present invention;

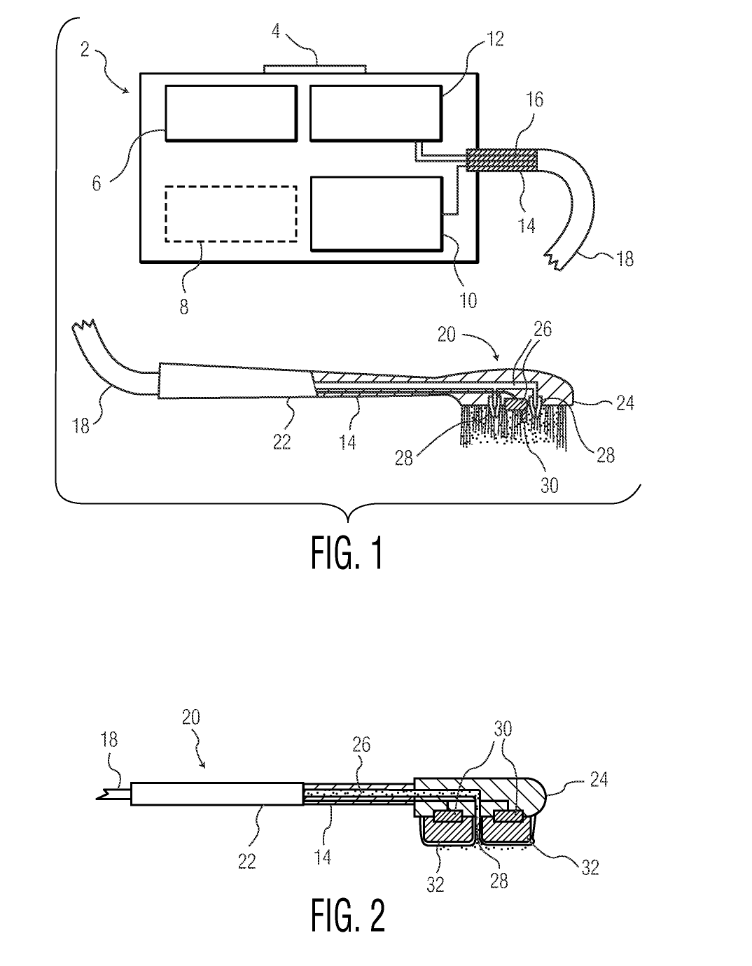

FIG. 2 is another example of an oral cleaning device according the present invention;

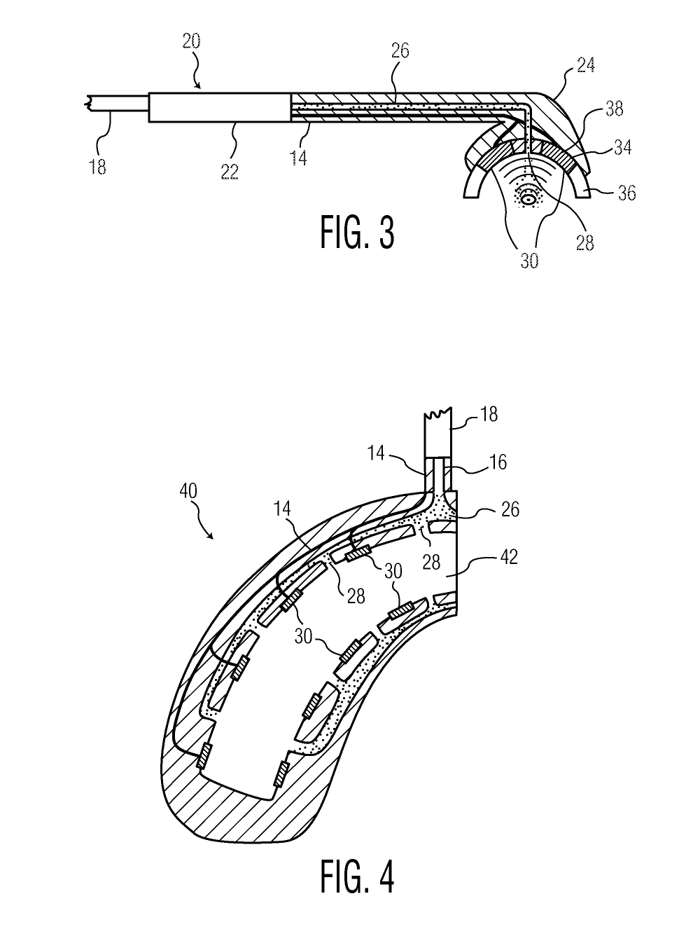

FIG. 3 is another example of an oral cleaning device example according to the present invention; and

FIG. 4 is still another example of an oral cleaning device according to the present invention.

The present invention is directed to removing biofilms from surfaces by gas bubbles resonated by ultrasound waves. Air bubbles in liquid medium cause vigorous fluid flows when excited with ultrasound frequencies near the resonance frequency. It has been shown that vibrating gas bubbles will induce acoustic streaming in a small volume near the bubble. The microscopic eddies formed around the bubble are known as microstreaming. Recently, it has been shown that fluid forces generated by a vibrating bubble on or near to a surface in a relatively low energy ultrasound field can deform and even break membrane vesicles.

Microstreaming causes a shear force which is capable of removing biofilm. The shear force S depends on the velocity gradient G excerted at the surface, and the viscosity of the liquid η:

S=ηG (1)

The velocity gradient is distributed over the boundary layer Lₘₛ. The thickness of this layer is given by:

Lₘₛ=\sqrt{η/πfρ} (2)

with ρ the density of the liquid and f the frequency of the vibration of the media in which the microstreaming is formed⁴. The velocity gradient G around the bubble that describes the drop of velocity in Lₘₛ is given by equation 2:

$$G = \frac{2 π {f ( R - {R}_{0} )}^{2}}{{R}_{0} {L}_{m s}} \qquad ( 3 )$$

Here R is the radius of the pulsating bubble and R₀ the equilibrium radius. So the shear stress S set up by this gradient is given by:

$$S = η G = \frac{2 {{π}^{3 / 2} ( R - {R}_{0} )}^{2} {( ρ {f}^{3} η )}^{1 / 2}}{{R}_{0}} \qquad ( 4 )$$

The maximum radius R will depend on the amplitude of the pressure wave, but another important factor is the resonance of the bubbles, which amplifies the bubble amplitude. The resonance frequency f₀ of the zero order oscillation is given for air bubbles with radius R₀ in water by:

f₀R₀≈3ms⁻¹ (5)

Equation 5 is useful to find an approximate optimal bubble size for a given resonance frequency of the bubbles. If an ultrasound wave has a frequency of 40 kHz, the optimal bubble radius would be approximately 75 μm. Further, if an ultrasound wave has a frequency of 1 MHz, then the optimal bubble radius would be approximately 3 μm. It should be noted that Equation 5 is an approximation and good results can be achieved by minor variations of ±20% in either f₀ or R₀. Also it should be noted that equation 5 is more accurate in regard to a single free bubble. If a bubble is close to a surface or to other bubbles, its resonance frequency may be higher.

It should be noted that the bubbles can also have higher modes of oscillation, that can also generate microstreaming and remove biofilms from surfaces. In these higher oscillation modes, the bubble shape may change. A factor to be considered is that the resonance frequencies of these higher order oscillations may differ from equation 5. For higher order (n>1) oscillations the resonance frequency relates to the bubble size according to:

$${f}_{n}^{2} = ( n - 1 ) ( n + 1 ) ( n + 2 ) \frac{σ}{4 {π}^{2} ρ {R}_{0}^{3}} \qquad ( 6 )$$

where σ is the surface tension of the liquid, and ρ the density. This means for example at 40 kHz that bubbles in water are resonant in the 2^{nd}, 3^{rd}, 4^{th}, 5^{th} and 6^{th} order oscillations when having radii of 24, 36, 47, 58 and 69 micrometers, respectively. At 1 MHz the same set of oscillations will occur with bubble radii of 2.8, 4.2, 5.5, 6.8, or 8.0 micrometers, respectively.

In view of the above, the present invention is directed to a device that removes biofilms from various surfaces. In one example, the device would be an oral cleaning device that removes plaque from hard to reach places in the mouth such as interproximal spaces or subgingival pockets. However, the present invention is not limited to just oral applications. A device according to the present invention would also be applicable to medical areas. For example, a device could be configured to remove infectious biofilms from implants, peritoneum, heart valves, sinuses, tonsils, middle ear or even organs such as bladders.

In all of the above-described applications, a device would include a number of basic elements such as a source of gas bubbles in a liquid medium, a source of ultrasound, outputting the bubbles with the liquid medium toward the target surface including the bio film and directing the ultrasound toward the target surface so that the bubbles in the liquid medium vibrate. As previously described, this vibrating bubble action will produce shear forces that will remove the biofilm from the target surface.

The source of gas bubbles in a liquid medium may be provided in a number of ways. However, in all of these ways the bubbles produced preferably should have a predetermined size in order to get the best results. In order to approximately determine this size, Equation 5 may be used. According to Equation 5, the approximate bubble size is related to its resonance frequency. It has also been found that a particular frequency range may be preferable for a practical device. This range is approximately between 20 KHz to 2 MHz. According to Equation 5, this would give a range of bubble radii to be approximately from 150 to 1.5 μm.

One way of producing the gas bubbles would be to mix a liquid and a gas in the device.

For example, a fast turning wheel in a mixing chamber fed by the liquid and gas. The bubble sizes of the majority of the bubbles would depend here on the velocity of the wheel, the dimensions and design of the wheel and mixing chamber and on the surface tension of the liquid. Further gas and water flows are important parameters. In general, this method will lead to a relatively broad bubble size distribution. Also, the gas could be blown in the liquid though a structure with small holes such as a filter. The size of the holes would determine the size of the bubbles, making a more narrow bubble size distribution. Further, a flow focusing nozzle setup also could be used to generate the gas bubbles in the liquid. The diameter of the nozzle opening, the gas pressure and the liquid pressure would determine the size of the bubble produced in the liquid, which can result in a very narrow bubble size distribution. In these cases, examples of the liquid that may be used include water or a premixed watery solution such as mouthwash or sodium chloride solution. The gas may be air, oxygen, carbondioxide, nitrogen, fluoroalkanes etc.

It should be noted that in bubble generation the surface tension of the liquid is often an important parameter. Lower surface tensions can be achieved for example by using pre-mixed watery solutions containing surface-active compounds, e.g. sodium laurylsulphate, proteins, phospholipids, poloxamers etc. If the surface tension is lower, it may be easier to generate smaller bubbles at the higher ultrasound frequencies.

Another way of producing the gas bubbles in a device would be to apply pre-fabricated gas bubbles in a liquid. The pre-fabricated mixture of liquid and bubbles would be stored in a storage tank in the device, and dispensed by an automatic or hand-driven pump. The dispensing of the bubbles would be in the same way as indicated below in the different embodiments. The prefabricated mixture could either be added to the embodiment as a refillable container to be refilled from a larger container for instance, or as a disposable sachet/container which can be provided separately. The prefabricated bubbles may require some stabilization to prevent dissolution by diffusion. This could be done through the application of specifically fabricated (polymer) shells. The bubbles also could be stabilized through solidification of dissolved proteins in the liquid at the bubble wall to generate a diffusion-blocking bubble wall. The bubbles may also be stabilized through careful selection of the gas and liquid so as to minimize bubble dissolution in the liquid, for instance bubbles in a gel matrix, or fluorpentane bubbles in a phospholipid solution.

Another alternative way of generating the bubbles could be by chemical action. For example, combining baking soda with citric acid will generate carbon dioxide bubbles. In this case, the apparatus may contain two separate containers, thus separating aqueous solutions of the reagents before use. During operation, the aqueous solutions would be output towards the surface that needs to be cleaned, where both solutions meet and generate bubbles. The concentrations of the reagents and other accompanying compounds should be carefully chosen to have the predetermined bubble size for sufficient time to do its cleaning action, i.e. the gas bubbles should not grow too fast.

The source of ultrasound could be realized by such devices as piezo-electric elements. Piezo-electric elements are devices for converting electrical energy into mechanical energy. A source of alternating electrical energy at a particular frequency would be used to excite the piezo-electric elements to produce ultrasound waves at the desired frequency. As previously described, the size of the bubble is related to the resonance frequency. Therefore, the particular frequency of the ultrasound wave should be close to or equal to this resonance frequency.

Directing the ultrasound toward the target surface may be accomplished by filling the space between the ultrasound source and target surface with a material that transmits ultrasound well. Ultrasound travels well though fluids, gels or rigid materials. However, it may be damped by gasses and soft elastic materials. Thus, it may be desirable that the number of bubbles between the transducer and the target be kept low. This may be accomplished by having the ultrasound source as close as possible to the target surface. Another option is to fill the space with a more rigid material, e.g. a viscous liquid, a gel or a solid, that stays between the ultrasound source and the bubble and liquid mixture flow. It may be desirable in oral applications if the more rigid material can adapt to the contour of the target surface to a certain extent, although it should not fully block the bubble and liquid mixture flow towards the surface.

One example of an oral cleaning device is shown in FIG. 1. As can be seen, the device includes a control unit 2 and an applicator 20. In this example, the applicator 20 is coupled to the control unit 2 by a flexible conduit 18. However, the present invention includes other ways of providing this coupling. For example, the control unit could be integrated into the applicator.

The control unit includes a user interface 4 that will enable the user to control the device. A power source 6 is also included that will provide electrical energy to power the device. The power source 6 may be an electrical battery, fuel cell or other portable energy container, or a power supply that plugs into an AC power line.

The control unit 2 may also include a toothbrush drive 8. However, the toothbrush drive 8 is shown in a dotted line since it may or may not be included depending on the type of applicator. In this example, the applicator is a toothbrush so that the toothbrush drive may be included. However, the toothbrush could also be used manually and thus the toothbrush drive 8 may not be included. If the toothbrush drive 8 is included it will include a motor and drive assembly necessary to move the toothbrush head back and forth similar to other known electrical toothbrushes.

Ultrasound drive electronics 10 is also included in the control unit 2 that provides electrical signals to create the ultrasound waves at the applicator 20. The ultrasound drive electronics 10 may be embodied by electronic circuits (analog, digital or combinations of these) as known in the art for driving ultrasound transducers. Specifically, the electronic circuit should deliver a periodic voltage with a frequency matching the ultrasound frequency. The transducer could either be driven in continuous mode (steering it with a stationary periodic voltage signal) or in pulsed mode (applying voltage pulses containing the right frequency), where the pulse frequency should be between 1 Hz and 1 Mhz.

In another setup, the ultrasound transducer would be of specific mechanical design, such that it has a resonance frequency matching the target frequency related to the bubble size. In this case, the transducer could be driven by appropriate pulses, as known from the art. Further, the ultrasound drive electronics 10 should operate at a predetermined frequency related to the size of the gas bubble produced. As previously described, a preferable operating frequency range may be approximately between 20 KHz to 2 MHz. Optimally, the ultrasound transducer should be resonant at a frequency close or at the drive frequency. As can be seen, the ultrasound drive 10 has an output wire 4 that extends into and through the flexible conduit 18. The output wire 4 will transfer signals from the ultrasound drive electronics 10 to the applicator 20.

The control unit 2 also includes a bubbled fluid source 12. This is the element that would produce the gas bubbles in a liquid medium. As previously described, this could be done in a number of ways. Further, the bubbles produced should have a predetermined size in order to get the best results. As previously described, the size of the bubble should be proportional to the frequency of the ultrasound source as expressed in Equation 5. In this example, a gel would be used to help direct the ultrasound waves to the target surface. Examples of a suitable gel include any compliant visco-elastic fluid that has low ultrasound damping properties, such as standard ultrasound gel, as is used in common practice in ultrasound imaging. Alternatively, the gel could be a toothpaste, adding toothpaste-like components (fluoride, abrasive particles) to the gel.

As can be further seen, a hose 16 is attached to the bubbled fluid source 12 that extends into the flexible conduit 18. The hose 16 will be used to transfer the bubbles and the liquid medium to the applicator 20. A pump included in the bubbled fluid source 12 will pump the liquid medium through the hose 16 to the applicator 20.

In this example, the applicator is a toothbrush 20. The toothbrush 20 includes a handle 22 and a brush head 24. The flexible conduit 18 is attached to the rear portion of the handle 22. As can be seen from this cross sectional view, the output wire 14 from the flexible conduit 18 also extends within the toothbrush 20 from the rear portion of the handle 22 to the brush head 24. This enables the ultrasound drive signals to be transferred to the ultrasound transducer 30 in the brush head 24. Further, a hollow channel 26 also extends from the rear portion of the handle 22 to the brush head 24. This channel 26 is connected to the hose 14 in the flexible conduit 18 and enables the bubbles in the liquid medium to be also carried to the brush head 24.

As can be further seen, nozzles 28 are included in the brush head 24 and are attached to the portions of the channel 26 that extend downward. The nozzles 28 will be used to output the bubbles and the liquid medium toward the target surface in the vicinity of the ultrasound waves. As previously mentioned, an ultrasound transducer 30 is included in the brush head 30. The ultrasound transducer may be embodied by a piezo-electric element or other similar device. The ultrasound transducer 30 will generate the ultrasound waves according to the drive signals from the ultrasound drive electronics 10

During operation, the bubbles in the liquid medium would be output from the nozzles 28 toward a target surface in the user's mouth. The ultrasound waves generated from the transducer 30 would also propagate toward the target surface through the gel in the liquid medium. These ultrasound waves will vibrate the bubbles in the liquid medium at the frequency of the ultrasound waves. As previously described, this vibrating bubble action will produce shear forces that are capable of removing biofilms from a variety of surfaces. Therefore, the above described action would remove any biofilms located on the target surface in a user's mouth.

Another example of an oral cleaning device is shown in FIG. 2. In this example, the same control unit described in regard to FIG. 1 would also be used. However, in this example, the applicator 20 is somewhat different. As can be seen, the applicator 20 has a handle 22 and head portion 24. The flexible conduit 18 is also attached to the rear portion of the handle 22. Further, the output wire 14 and hollow channel 26 also extend from the rear portion of the handle 22 to the head 24.

However, as can be seen, the head portion 24 does not have any toothbrush bristles. Instead, the head portion includes two ultrasound transducers 30 connected to the output wire 14. Further, disposed over each transducer 30 is a gel pack 32. The gel packs 30 will be used to transmit the ultrasound waves toward the target surface. In this example, by using the gel packs, there is no need to include extra gel between the transducer and the bubble-liquid medium mixture provided by the bubbled fluid source in the control unit. Similar to the previous example, during operation, the bubbles in the liquid medium would be output from the outlet 28 in the head portion 24 toward a target surface in the user's mouth. The ultrasound waves generated from the two transducers 30 would also propagate toward the target surface in the gel packs 32. These ultrasound waves will vibrate the bubbles in the liquid medium. This vibrating bubble action would produce shear forces that would remove bio films from target surfaces in the user's mouth.

Another example of an oral cleaning device is shown in FIG. 3. In this example, the same control unit described in regard to FIG. 1 would also be used. Further, the applicator would also include a handle 22 and head portion 24, as described previously.

However, in this example, the head portion 24 is different. As can be seen from the cross sectional view, the head portion 24 has an upwardly curving lower surface 34. Disposed in this lower surface 34 is a cup member 36. The cup member 36 would help focus the ultrasound waves toward the target surface. The shape of the cup member is used to focus the ultrasound waves and also to reduce the fluid spilling. In this example, gel may also be included in the liquid medium, as previously described. The cup member 36 would be preferably fabricated from a flexible pliable material such as rubber or other polymer elastomers.

As can be seen, in this example, ultrasound transducers 30 are included in the cup member 36 near the middle of the lower surface 34. Further, an opening 28 is included in the cup member 36 between the transducers 30. During operation, the opening 28 would serve as an outlet for the gas bubbles in the liquid medium. Thus, the gas bubbles in the liquid medium would be output from this opening 28 toward the target surface. Further, the ultrasound waves generated from the transducers 30 would be also be focused towards the target surface by the cup member 36. These ultrasound waves would vibrate the bubbles in the liquid medium. This vibrating bubble action would produce shear forces that would remove biofilms from target surfaces in the user's mouth.

Another example of an oral cleaning device is shown in FIG. 4. In this example, the same control unit described in regard to FIG. 1 would also be used. However, in this example, the applicator is in the form of a mouth guard 40. The mouth guard 40 includes an inner cut out portion 42. The cut out portion 42 would be in the shape encompassing the user's dentition, and the outside dimensions would enable it to be placed in a mouth during operation. To make sure that this embodiment fits, it could be custom-made to fit in the user's mouth. Alternatively or additionally, it could be made from a flexible material as to make it comply with the shape of the user's mouth and dentition. Alternatively again one could offer a range of shape suited to fit different sizes of users mouths for optimal wearing comfort.

A plurality of ultrasound transducers 30 would be included adjacent to the cutout. The output wire 14 from the flexible conduit 18 extends into the mouth guard around the cut out portion 42, as shown. This enables the output wire 14 to be connected to all of the transducers 30 to receive the drive signals from the control unit. Also, extending around the cut out portion 42 is a hollow channel 26. The channel 26 is connected to the hose 16 in the hollow conduit 18 in order to circulate the liquid medium with the gas bubbles around the mouth guard 40. Adjacent to the transducers 30 are openings 28 for the channel 26. These opening 28 would serve as an outlet for the gas bubbles in the liquid medium.

During operation, the mouth guard would be placed in a user's mouth so that the transducers 30 and openings 28 would be adjacent to the user's teeth. The gas bubbles and the liquid medium mixture would be output from the openings 28 towards target surfaces on the teeth. Further, the ultrasound waves generated from the transducers 30 would also propagate toward the target surfaces. These ultrasound waves would vibrate the bubbles in the liquid medium. This vibrating bubble action would produce shear forces that would remove bio films from the target surfaces.

While the present invention has been described above in terms of specific examples, it is to be understood that the invention is not intended to be confined or limited to the examples disclosed herein. Therefore, the present invention is intended to cover various structures and modifications thereof included within the spirit and scope of the appended claims.

1. An oral cleaning device, comprising: a unit providing a source of bubbles in a liquid medium, the bubbles having a predetermined size; an applicator coupled to the unit including at least one outlet for outputting the bubbles in the liquid medium and at least one ultrasound transducer for providing a source of ultrasound waves for vibrating the bubbles at a predetermined frequency, wherein the predetermined size of the bubbles is approximately related to the frequency of the ultrasound waves by:
f₀R₀≈3ms⁻¹
where f₀ is the frequency of the ultrasound waves and R₀ is the radius of the bubbles.

2. The device of claim 1, wherein the frequency of the ultrasound waves is in the range of 20 KHz to 2 MHz.

3. The device of claim 1, wherein the liquid medium includes a gel.

4. The device of claim 1, wherein the applicator includes a handle and a head portion.

5. The device of claim 4, wherein the at least one outlet is two nozzles in the head portion.

6. The device of claim 5, wherein the at least one ultrasound transducer is in the head portion.

7. The device of claim 6, where the at least one ultrasound transducer is disposed between the two nozzles.

8. The device of claim 4, wherein the at least one ultrasound transducer is two ultrasound transducers in the head portion.

9. The device of claim 8, further comprising a gel pack disposed over each of the ultrasound transducers.

10. The device of claim 8, wherein the at least one outlet is disposed between the ultrasound transducers.

11. The device of claim 4, further comprising a cup member disposed in the head portion.

12. The device of claim 11, wherein the cup member is of a flexible material.

13. The device of claim 11, wherein the at least one ultrasound transducer is two ultrasound transducers disposed in the cup member.

14. The device of claim 13, wherein the at least one outlet is disposed between the ultrasound transducers.

15. The device of claim 1, wherein the applicator is a mouth guard.

16. The device of claim 15, wherein the mouth guard includes a cut out shaped according to a mouth of a user.

17. The device 16, wherein the at least one transducer is a plurality of transducers located adjacent to the cut out.

18. The device 16, wherein the at least one outlet is a plurality of outlets located adjacent to the cut out.

19. A method of removing biofilms from a surface, comprising the steps of: providing a source of bubbles in a liquid medium, the bubbles having a predetermined size; providing a source of ultrasound waves at a predetermined frequency;
outputting the bubbles in the liquid medium toward the surface; and directing the ultrasound waves toward the surface so that the bubbles vibrate at the predetermined frequency of the ultrasound; wherein the predetermined size of the bubbles is approximately related to the frequency of the ultrasound waves by:
f₀R₀≈3ms⁻¹
where f₀ is the frequency of the ultrasound waves and R₀ is the radius of the bubbles.

20. The method of claim 19, wherein the frequency of the ultrasound waves is in the range of 20 KHz to 2 MHz.
